(19) United States
(12) Patent Application Publication
(10) Pub. No.: US 2026/0276667 A1
(43) Pub. Date: Sep. 17, 2026

(54) FLOW PATH DEVICE AND DETECTION DEVICE

(71) Applicant: KYOCERA Corporation, Kyoto (JP)

(72) Inventors: Yasuhito KANEMAKI, Katano-shi, Osaka (JP); Hajime SASAKI, Hiroshima-shi, Hiroshima (JP)

(21) Appl. No.: 19/168,819

(22) PCT Filed: Mar. 27, 2024
(86) PCT No.: PCT/JP2024/012405

§ 371 Date: Sep. 25, 2025

(30) Foreign Application Priority Data
Mar. 27, 2023 (JP) 2023-050122

(51) Int. Cl. G01N 35/08; B01J 19/00; G01N 37/00

(52) U.S. Cl. CPC G01N 35/08; B01J 19/00; G01N 37/00

(57) ABSTRACT

A flow path device includes a first member having a pair of first main surfaces and a groove with an opening located in one of the first main surfaces, and a second member having a pair of second main surfaces, one surface of the pair of second main surfaces is joined to the one surface of the pair of first main surfaces of the first member, and closes the opening, wherein the first member or the second member includes a through hole connected to the groove, and in plan view, a corner portion is formed at the edge of the groove, and no corner portion is formed at the edge of the groove opposite to the corner portion.

### CROSS-REFERENCE TO RELATED APPLICATION(S)

This application is a national stage application of International Application No. PCT/JP 2024/012405, filed on Mar. 27, 2024, which designates the United States, and which claims the benefit of priority from Japanese Patent Application No. 2023-050122, filed on Mar. 27, 2023.

### TECHNICAL FIELD

The present disclosure relates to a flow path device and a detection device.

### BACKGROUND OF INVENTION

A flow path device with a first member including a groove as a flow path and a second member joined to the first member is known (see, for example, Patent Document 1).

### CITATION LIST

### Patent Literature

Patent Document 1: JP 2020-18999 A

### SUMMARY

A flow path device according to an aspect of the present disclosure, includes
a first member having
a pair of first main surfaces and
a groove with an opening located in one of the first main surfaces, and
a second member having a pair of second main surfaces,
one surface of the pair of second main surfaces being joined to the one surface of the pair of
first main surfaces of the first member, and closing the opening, wherein the first member or
the second member includes a through hole connected to the groove,
in plan view, a corner portion is formed at the edge of the groove, and
no corner portion is formed at the edge of the groove opposite to the corner portion.

### BRIEF DESCRIPTION OF THE DRAWINGS

FIG. 1 is a top view of a detection device according to a first embodiment.

FIG. 2 is a side view of the detection device according to the first embodiment.

FIG. 3 is a plan view of a separation flow path device according to the first embodiment.

FIG. 4 is a cross-sectional view taken along a line B-B illustrated in FIG. 3.

FIG. 5 is an enlarged plan view of a region I illustrated in FIG. 3.

FIG. 6 is a plan view of the separation flow path device according to the first embodiment.

FIG. 7 is an enlarged plan view of a region II illustrated in FIG. 6.

FIG. 8 is a cross-sectional view taken along a line C-C illustrated in FIG. 7.

FIG. 9 is a cross-sectional view taken along a line D-D illustrated in FIG. 7.

FIG. 10 is a view illustrating another example of the configuration of a corner portion and the first relief groove according to the first embodiment in plan view.

FIG. 11 is a view illustrating a base flow path device according to the first embodiment in plan view.

FIG. 12 is a cross-sectional view taken along a line E-E illustrated in FIG. 11.

FIG. 13 is a plan view of the detection device according to the first embodiment.

FIG. 14A is a plan view of only the first member illustrated in FIG. 13.

FIG. 14B is a plan view of only the second member illustrated in FIG. 13.

FIG. 14C is a plan view of only the third member illustrated in FIG. 13.

FIG. 15 is a cross-sectional view taken along a line F-F illustrated in FIG. 13.

FIG. 16 is a plan view of a separation flow path device according to a second embodiment.

FIG. 17 is an enlarged plan view of a region III illustrated in FIG. 16.

FIG. 18 is a cross-sectional view taken along a line G-G illustrated in FIG. 17.

FIG. 19 is a plan view illustrating another example of the configuration of a corner portion according to the second embodiment.

FIG. 20 is a plan view of a detection device according to the second embodiment.

FIG. 21 is a cross-sectional view taken along a line H-H illustrated in FIG. 20.

FIG. 22 is a plan view of a part of a separation flow path device according to a third embodiment.

FIG. 23 is a cross-sectional view taken along a line J-J illustrated in FIG. 22.

FIG. 24 is a plan view illustrating another example of the configuration of a recessed portion according to the third embodiment.

### DESCRIPTION OF EMBODIMENTS

Flow path devices and detection devices according to the embodiments of the present invention will be described below with reference to the drawings. In the present disclosure, for convenience, a rectangular coordinate system (X, Y, Z) is defined such that the positive side in the Z-axis direction is upward and the negative side in the Z-axis direction is downward. In the present disclosure, a plan view means a view from the positive side in the Z-axis direction.

Note that the drawings used in the following description are schematic only, and the dimensional ratios in the drawings do not necessarily match those in the actual drawings.

Even in a plurality of drawings illustrating the same configuration, the dimensional ratio or the like may not match each other in order to exaggerate the shape.

### First Embodiment

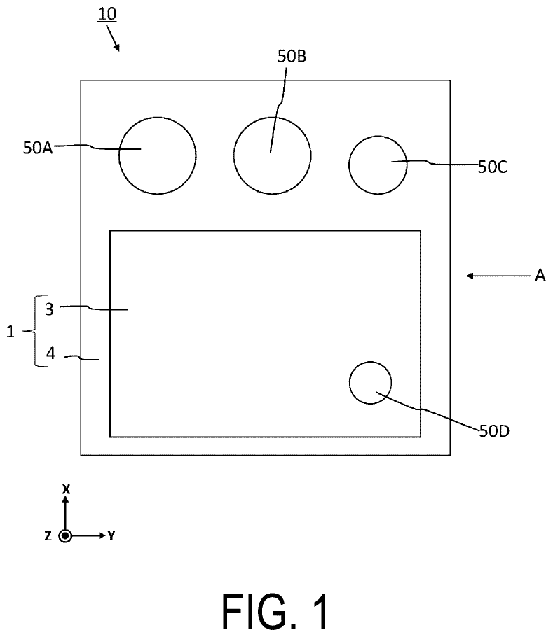

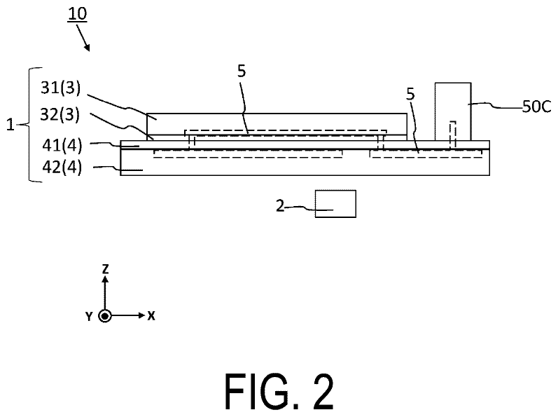

A detection device 10 according to the present embodiment will be described with reference to FIGS. 1 and 2. FIG. 1 is a top view of the detection device 10. FIG. 2 is a side view of the detection device 10 viewed from A in FIG. 1.

The detection device 10 can separate specific particles in the fluid and collect the separated particles. A separation flow path device 3 according to the present embodiment can separate white blood cells as specific particles from the blood as the fluid and collect the separated white blood cells. The detection device 10 includes a flow path device 1 and a detector 2. In addition, the flow path device 1 includes the separation flow path device 3 and a base flow path device 4. The separation flow path device 3 includes a first member 31 and a second member 32. The base flow path device 4 includes a third member 41 and a fourth member 42. The flow path device 1 includes a flow path 5 in each of the separation flow path device 3 and the base flow path device 4, and fluid flows in the flow path 5. The separation flow path device 3 includes the flow path 5 for separating and extracting specific particles from the fluid and sorting them. The base flow path device 4 includes supply units 50A, 50B and 50C for flowing fluid into the flow path 5. The base flow path device 4 includes the flow path 5 for supplying the fluid flowing in from the supply units 50A, 50B and 50C to the separation flow path device 3, and the flow path 5 for collecting the fluid flowing therein from the separation flow path device 3.

The detector 2 according to the present embodiment is an optical sensor that includes a light emitting element and a light receiving element. The detector 2 is positioned on the negative side of the Z-axis of flow path device 1. The detector 2 can detect leakage of fluid flowing in the flow path 5.

The flow path device 1 includes a reservoir portion 50D for collecting fluid containing separated specific particles. The reservoir portion 50D is formed by including a hole penetrating through and the first member 31, the second member 32, and the third member 41, which are open on the respective upper and lower surfaces, and a recessed portion that opens on the upper surface of the fourth member 42. In other words, the depth of the reservoir portion 50D is the sum of each thickness of the first member 31, the second member 32, the third member 41, and the depth of the recessed portion formed on the fourth member 42.

The fluid containing separated specific particles collected in the reservoir portion 50D is collected, for example, using a suction device such as a syringe. The collected fluid can be analyzed by, for example, concentration measurement or optical measurement. The collected fluid can be used as a sample for experiments such as chemical reactions.

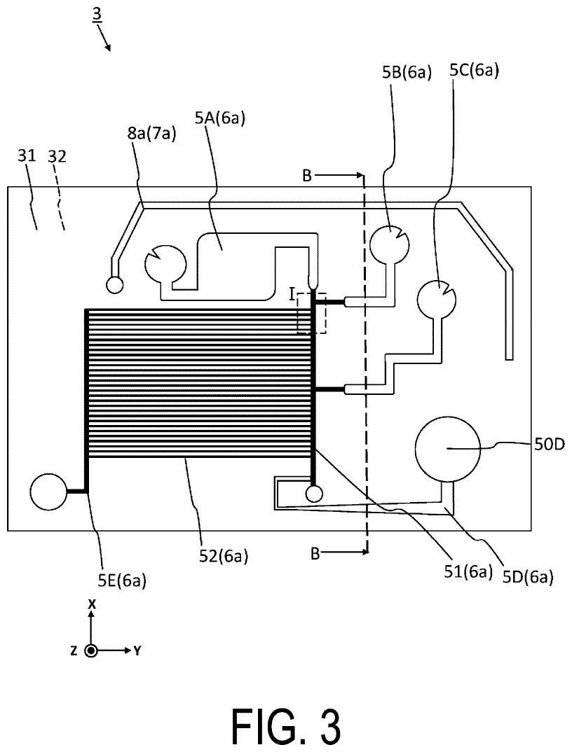

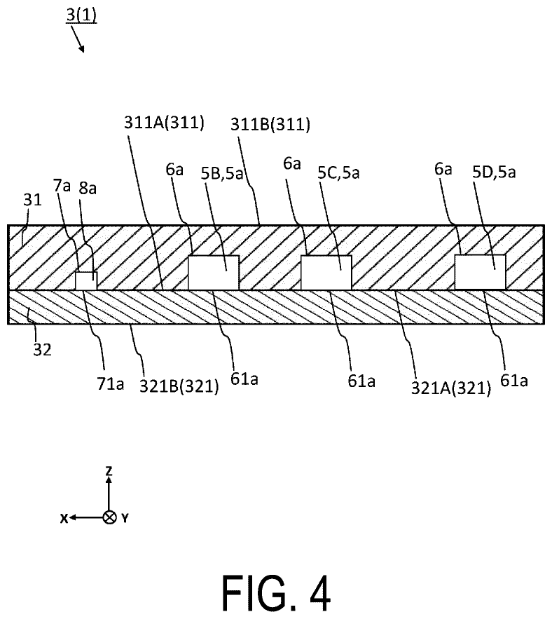

The separation flow path device 3 will be described with reference to FIGS. 3 and 4. FIG. 3 is a plan view of the separation flow path device 3. FIG. 4 is a cross-sectional view of the separation flow path device 3 taken along a line B-B illustrated in FIG. 3. Note that FIG. 3 is a plane perspective view of the separation flow path device 3.

The first member 31 is, for example, a flat plate member. The first member 31 includes a pair of first main surfaces 311 as upper and lower surfaces thereof. In the first member 31 according to the present embodiment, among the pair of first main surfaces 311, the first main surface 311 located in the positive direction of the Z-axis is defined as the other surface 311B of the pair of first main surfaces, and the first main surface 311 located in the negative direction of the Z-axis is defined as one surface 311A of the pair of first main surfaces. The first member 31 includes a first groove 6a, and the first groove 6a includes an opening 61a located in the one surface 311A of the pair of first main surfaces. The first member 31 includes a first relief groove 7a, which includes an opening 71a located in the one surface 311A of the pair of first main surfaces.

The second member 32 is, for example, a flat plate member. The second member 32 includes a pair of second main surfaces 321 as upper and lower surfaces thereof. In the second member 32 according to the present embodiment, among the pair of second main surfaces 321, the second main surface 321 located in the positive direction of the Z-axis is defined as one surface 321A of the pair of second main surfaces, and the second main surface 321 located in the negative direction of the Z-axis is defined as the other surface 321B of the pair of second main surfaces.

In the second member 32, one surface 321A of the pair of second main surfaces is joined to the one surface 311A of the pair of first main surfaces of the first member 31. The second member 32 is joined so as to close the opening 61a of the first groove 6a of the first member 31. Furthermore, the second member 32 is joined so as to close the opening 71a of the first relief groove 7a of the first member 31. Thus, by joining the first member 31 and the second member 32, the first groove 6a including the opening 61a of the first member 31 is configured as a first flow path 5a, and the first relief groove 7a including the opening 71a of the first member 31 is configured as a first relief flow path 8a. Unlike the first flow path 5a, the first relief flow path 8a does not receive fluid from the outside of the flow path device 1. That is, during the use of the flow path device 1 such as for separating white blood cells from the blood, no fluid flows in the first relief flow path 8a except when leakage occurs from the first flow path 5a.

The first flow path 5a in the separation flow path device 3 according to the present embodiment consists of flow paths 5A, 5B, 5C, 5D, 5E, a pressing flow path 51, and a branch flow path 52. A first fluid containing a specific particle to be separated flows in a flow path 5A. For example, the first fluid is blood, and the specific particle is a white blood cell. In the flow path 5B, the second fluid for pressing the first fluid from the pressing flow path 51 to the branch flow path 52 flows. For example, the second fluid is saline. In the flow path 5° C., similar in the flow path 5B, the second fluid for pressing the first fluid from the pressing flow path 51 to the branch flow path 52 flows. The first fluid from the pressing flow path 5A and the second fluid from the flow paths 5B and 5C flow into the pressing flow path 51.

When the first fluid is pressed by the second fluid in the pressing flow path 51, a particle different from a specific particle flows into the branch flow path 52. In the pressing flow path 51, the further away from the confluence of flow path 5B and the pressing flow path 51, the weaker the force of the second fluid to press the first fluid. Thus, by providing the confluence of the flow path 5C and the pressing flow path 51 at the intermediate point in the X-axis direction of the pressing flow path 51, the weaker force of the second fluid to press the first fluid can be prevented in the pressing flow path 51.

From the pressing flow path 51, a third fluid containing a particle different from the specific particle flows into the branch flow path 52, a fourth fluid containing the specific particle flows into a flow path 5D, and other fifth fluid flows directly through the pressing flow path 51. The flow path 5D is connected to the reservoir portion 50D, and a fourth fluid containing the specific particle gathers into the reservoir portion 50D. A third fluid containing the particle different from the specific particle flows into the flow path 5E from a plurality of branch flow paths 52.

The width of the first groove 6a may be, for example, 30 μm to 4000 μm. The depth of the first groove 6a may be, for example, 10 μm to 1000 μm. The width of the first relief groove 7a may be, for example, 20 μm to 1000 μm. The depth of the first relief groove 7a may be, for example, 5 μm to 500 μm. The first groove 6a and the first relief groove 7a may be formed by, for example, known techniques such as mold, etching, laser machining process, or the like. Note that the width and depth of the first groove 6a and the first relief groove 7a are the same as the width and height of the first flow path 5a and the first relief flow path 8a, respectively.

The first member 31 and the second member 32 may be, for example, joined via adhesive, plasma bonding, or optical bonding. In the case of joining via adhesive, for example, UV curable adhesive or thermosetting adhesive may be used. In the case of plasma bonding, for example, oxygen plasma is applied. In the case of optical bonding, for example, ultraviolet light from an excimer lamp is applied.

The material of the first member 31 may be, for example, PDMS (polydimethylsiloxane) or PMMA (polymethylmethacrylate: acrylic) resin, glass, polycarbonate resin, or the like. The material of the first member 31 according to the present embodiment is PDMS. The thickness of the first member 31 may be, for example, 1 mm to 5 mm.

The material of the second member 32 may be, for example, silicone, PDMS (polydimethylsiloxane) resin, PMMA (polymethylmethacrylate: acrylic) resin, glass, polycarbonate resin, or the like. The material of the second member 32 according to the present embodiment is silicone, especially silicone rubber. The thickness of the second member 32 may be, for example, 0.5 mm to 4 mm. Note that the thickness of the second member 32 according to the present embodiment is smaller than that of the first member 31. The length of the first member 31 and the second member 32 may be, for example, 10 to 50 mm along the Y-axis direction and 10 to 30 mm along the X-axis direction, respectively.

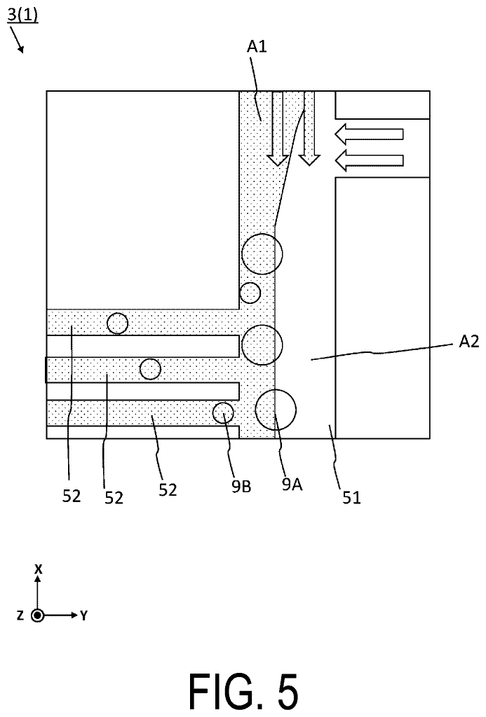

The state of separation in the separation flow path device 3 according to the present embodiment will be described with reference to FIG. 5. FIG. 5 is an enlarged plan view of the region I illustrated in FIG. 3. Note that FIG. 5 illustrates the separation flow path device 3 in plane perspective.

In the following, the specific particle described above is defined as a particle 9A, and the particle different from the particle 9A is defined as a particle 9B, and the state of separation between the particle 9A and the particle 9B will be described in detail. In the separation flow path device 3 according to the present embodiment, a “pull-in flow” flowing from the pressing flow path 51 to the branch flow path 52 can be generated within the pressing flow path 51, by adjusting the cross-sectional area, length, of the pressing flow path 51 and the branch flow path 52, and flow rate of the first fluid and the second fluid. A hatched first region Al indicates a “pull-in flow”. Then, in the pressing flow path 51, a “pressing flow” is generated in which the second fluid can push the first fluid toward the branch flow path 52. A second region A2, which is a region other than the first region A1, indicates the “pressing flow”.

As a result, by making the width of the branch flow path 52 smaller than the size of the particle 9A flowing through the first fluid and larger than the size of the particle 9B, the particle 9B can be pulled in the branch flow path 52. Also, by making the width of the pull-in flow flowing through the branch flow path 52 side of the pressing flow path 51 larger than the position of the center of gravity of the particle 9B flowing through the first fluid and smaller than the position of the center of gravity of the particle 9A, the particle 9B can be effectively pulled into the branch flow path 52. Thus, the fourth fluid containing the particle 9A can be collected by separating the particle 9A of the first fluid, which is then caused to flow into the flow path 5D from the pressing flow path 51. Note that at the same time, the third fluid containing the particle 9B can also be collected by separating the particle 9B from the first fluid, which is then caused to flow into the flow path 5E from the branch flow path 52. Note that the particles 9B are designed to flow into the branch flow path 52, which is, however, not limited to only the particles 9B. That is, particles different from the particles 9B may flow into the branch flow path 52.

The separation flow path device 3 according to the present embodiment is specifically intended to separate red blood cells and white blood cells in the blood. Note that the center of gravity of the red blood cell in the blood is, for example, 2 to 2.5 μm from the edge, and the center of gravity of the white blood cell is, for example, 5 to 10 μm from the edge. In this case, the pressing flow path 51 may have, for example, a cross-sectional area of 300 μm² to 1000 μm² , and a length of 0.5 mm to 20 mm. The branch flow path 52 may have, for example, a cross-sectional area of 100 μm² to 500 μm², and a length of 3 mm to 25 mm. The flow velocity in the pressing flow path 51 may be, for example, 0.2 m/s to 5 m/s. As a result, the width of the pull-in flow can be set to, for example, 2 μm to 15 μm, and the red blood cells and white blood cells can be separated from the blood.

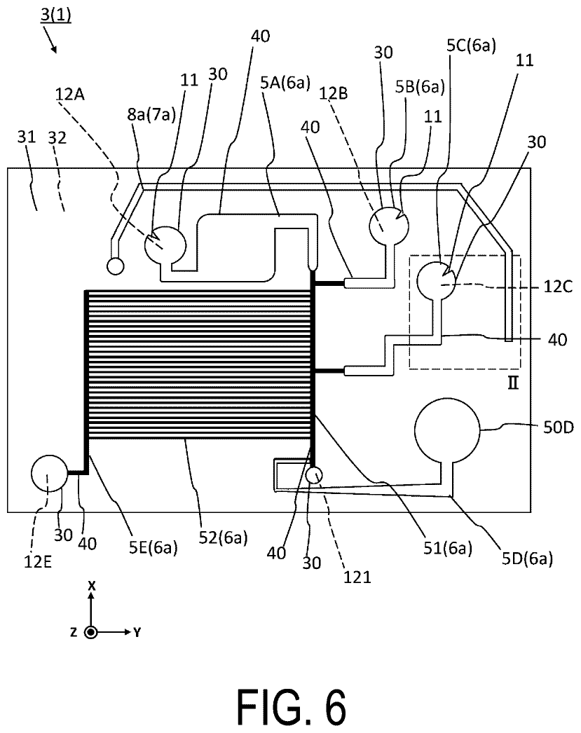

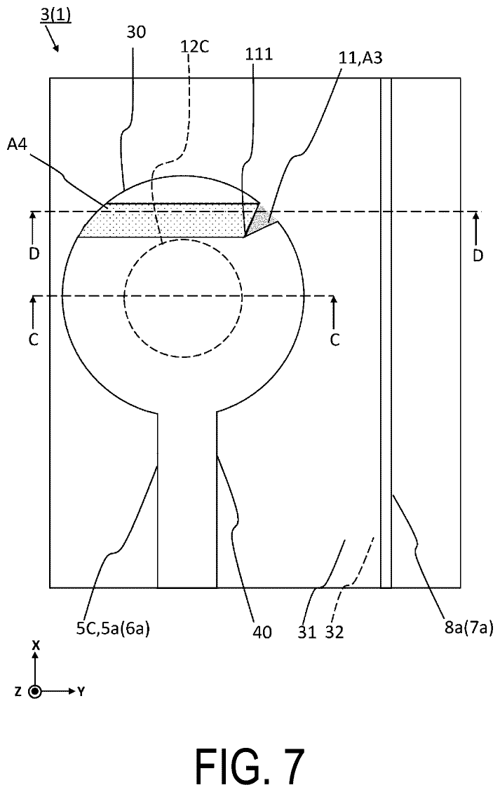

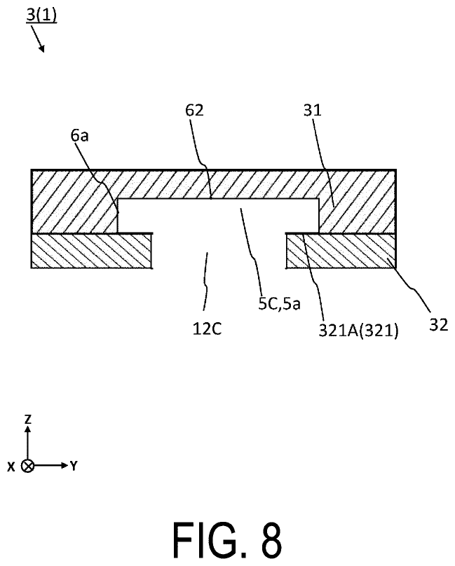

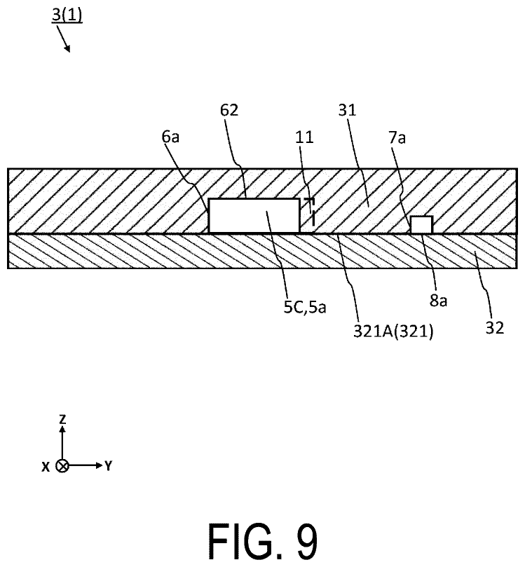

Referring to FIGS. 6, 7, 8, and 9, the configuration of a corner portion 11 formed at the edge of the first groove 6a, and of the vicinity of the corner portion 11 will be described. FIG. 6 is a plan view of the separation flow path device 3 as in FIG. 3. FIG. 7 is an enlarged plan view of the region II illustrated in FIG. 6. FIG. 8 is a cross-sectional view of the separation flow path device 3 taken along a line C-C illustrated in FIG. 7. FIG. 9 is a cross-sectional view of the separation flow path device 3 taken along a line D-D illustrated in FIG. 7. Note that FIGS. 6 and 7 illustrate the separation flow path device 3 in plane perspective.

The second member 32 includes through holes 12A, 12B, 12C, 12E, and 121 connected to the first groove 6a. The through holes 12A, 12B, 12C, 12E, and 121 are connected to the flow paths 5A, 5B, 5C, 5E, and the first groove 6a constituting the pressing flow path 51, respectively. In the flow path device 1 according to the present embodiment, the through holes 12A, 12B, 12C, 12E, and 121 connected to the first groove 6a are provided in the second member 32, but may be provided in the first member 31.

The through hole 12A functions as an inflow opening for the first fluid to the flow path 5A. The through holes 12B, 12C function as an inflow opening for the second fluid to the flow paths 5B, 5C, respectively. The through hole 12E functions as an outflow opening for the third fluid from the flow path 5E. A through hole 121 functions as an outflow opening for the fifth fluid from the pressing flow path 51.

Here, when the first fluid flows into the flow path 5A via the through hole 12A, the second fluid flows into the flow paths 5B and 5C via the through holes 12B and 12C, or the third fluid flows out from the through hole 12E via the flow path 5E, and the fifth fluid flows out from the through hole 121 via the pressing flow path 51, the pressure is applied to the respective inner walls of the first grooves 6a provided in the first member 31 constituting the flow paths 5A, 5B, 5C, 5E and the pressing flow path 51, and to the one surface 321A of the second main surfaces of the second member 32 constituting the flow paths 5A, 5B, 5C, 5E, and the pressing flow path 51. Specifically, a pushing force acts on a bottom wall 62 of the inner wall of the first groove 6a in the first member 31, in a direction opposite to the side where the second member 32 is disposed, and a pushing force acts on the one surface 321A of the second main surfaces of the second member 32, in a direction opposite to the side where the first member 31 is disposed. This could separate the first member 31 and the second member 32, which were joined in surface contact between the one surface 311A of the first main surfaces of the first member 31 and the one surface 321A of the second main surfaces of the second member 32. Accordingly, so-called fluid leakage could occur, in which the first fluid flowing through the flow path 5A, the second fluid flowing through the flow paths 5B and 5C, the third fluid flowing through the flow path 5E, and the fifth fluid flowing through the pressing flow path 51 flow into a separated gap that has been formed between the first member 31 and the second member 32. In the known flow path device, such a fluid leakage could occur from any part of the edge of the first groove 6a.

Thus, in the flow path device 1 according to the present embodiment, the corner portion 11 is formed at the edge of the first grooves 6a each constituting the flow paths 5A, 5B, and 5C, and the corner portion 11 is not formed at the edge of the first groove 6a opposite to the corner portion 11. Here, the “corner portion” is a triangular region formed by two half-lines forming a corner 111 in plan view. In FIG. 7, a third region A3 illustrated in gray indicates the corner portion 11. Further, “opposite to” means opposite to the first groove 6a when viewed in the width direction. In the first groove 6a that constitutes the flow path 5A, the corner portion 11 is located on the negative side of the Y-axis in the first groove 6a, so that the edge of the first groove 6a opposite to the corner portion 11 is the edge of the first groove 6a that is located on the positive side of the Y-axis. In the first groove 6a that constitutes each of the flow paths 5B and 5C, the corner portion 11 is located on the positive side of the Y-axis, so that the edge of the first groove 6a that opposite to the corner portion 11 is the edge of the first groove 6a that is located on the negative side of the Y-axis in the first groove 6a than the corner portion 11. In FIG. 7, a hatched fourth region A4 indicates a region opposite to the corner portion 11.

As described above, the corner portion 11 is formed at the edge of the first groove 6a that constitutes each of the flow paths 5A, 5B and 5C, and the corner portion 11 is not formed at the edge of the first groove 6a opposite to the corner portion 11. As a result, the balance of the stress applied by the first fluid or the second fluid to the edge of the first groove 6a is lost. Specifically, the stress applied to the corner portion 11 is larger than the stress applied to the edge of the first groove 6a opposite to the corner portion 11. Thus, the stress is concentrated on the corner 111 of the corner portion 11, and there is a high possibility that the first member 31 and the second member 32 separate from each other originating from the corner 111. As described above, in the flow path device 1 according to the present embodiment, the corner portion 11 is intentionally formed at the edge of the first groove 6a that constitutes each of the flow paths 5A, 5B, and 5C. As a result, if the first member 31 and the second member 32 separate from each other, there is a high possibility that this separation originates from the corner 111. Thus, the leakage of the first fluid or the second fluid can be reliably detected by monitoring only the periphery of the corner portion 11 without monitoring all of the peripheries of the first grooves 6a in the flow path device 1. This allows the flow path device 1 according to the present embodiment to promptly take countermeasure against the leakage of the first fluid or the second fluid.

In the flow path device 1 according to the present embodiment, the corner portion 11 may also be provided at the edge of the first groove 6a constituting the flow path 5E or the edge of the first groove 6a constituting the pressing flow path 51. Note that in the flow path device 1 according to the present embodiment, the flow paths 5A, 5B, and 5C are located upstream of the flow path 5E and the pressing flow path 51 in the first flow path 5a of the separation flow path device 3. Thus, the first fluid flowing through the flow path 5A and the second fluid flowing through the flow paths 5B and 5C have a higher pressure applied to the inner wall of the first groove 6a and the one surface 321A of the second main surfaces than the third fluid flowing through the flow path 5E and the fifth fluid flowing through the pressing flow path 51. Thus, in the flow path device 1 according to the present embodiment, the so-called leakage of fluid is highly likely to occur in the flow paths 5A, 5B, and 5C, so that the corner portion 11 is formed only at the edge of the first groove 6a constituting each of the flow paths 5A, 5B, and 5C.

Here, when viewed in plan view, the first groove 6a includes a first planar portion 30 that is circular including the corresponding one of the through holes 12A, 12B, 12C, 12E, and 121, and a strip shape second planar portion 40 connected to the first planar portion 30. The first planar portion 30 is a circular portion including the corresponding one of the through holes 12A, 12B, 12C, 12E, and 121 in the first groove 6a. The first planar portion 30 of the first groove 6a constituting the flow path 5A is a portion where the first fluid flows in the thickness direction via the through hole 12A. The first planar portion 30 of the first groove 6a constituting the flow paths 5B and 5C is the portion where the second fluid flows in the thickness direction via the through holes 12B and 12C, respectively. The first planar portion 30 of the first groove 6a constituting the flow path 5E is the portion where the third fluid flows out in the thickness direction via the through hole 12E. The first planar portion 30 of the first groove 6a constituting the flow path 51 is the portion where the fifth fluid flows out in the thickness direction via the through hole 121.

Thus, the pressure applied to the inner wall of the first groove 6a and the one surface 321A of the second main surfaces in the first planar portion 30 is larger than the pressure applied to the inner wall of the first groove 6a and the one surface 321A of the second main surfaces in the second planar portion 40. Thus, in the flow path device 1 according to the present embodiment, the corner portion 11 is formed at the edge of the first planar portion 30 of the first groove 6a constituting each of the flow paths 5A, 5B, and 5C, and the corner portion 11 is not formed at the edge of the first planar portion 30 opposite to the corner portion 11. As a result, if the first member 31 and the second member 32 separate from each other, there is a high possibility that the stress is concentrated on the corner 111 of the corner portion 11 at the edge of the first planar portion 30 of the first groove 6a constituting the flow paths 5A, 5B, 5C, and thereby this separation is likely to originate from the corner 111 of the corner portion 11. This can reliably detect the leakage of the first fluid or the second fluid by monitoring only the periphery of the corner portion 11 formed at the edge of the first planar portion 30 of the first groove 6a constituting the flow paths 5A, 5B, 5C, without monitoring all of the peripheries of the first grooves 6a in the flow path device 1.

The corner portion 11 forms the corner 111 in the direction toward each of the through holes 12A, 12B, 12C in plan view. This allows the corner 111 to approach each of the through holes 12A, 12B, and 12C, and thus concentrates more stress on the corner 111. Thus, the first member 31 and the second member 32, when separating, are more likely to separate from each other originating from the corner 111. Thus, the leakage of the first fluid or the second fluid can be reliably detected by monitoring only the periphery of the corner portion 11 formed at the edge of the first planar portion 30.

In the flow path device 1 according to the present embodiment, the first relief groove 7a is provided in the vicinity of the corner portion 11 in plan view.

The first relief groove 7a is provided in the vicinity of the corner portion 11, and thus when the first member 31 and the second member 32 separate from each other originating from the corner 111 of the corner portion 11, the first fluid or the second fluid, which has flown in from the separated portion, flows out to the first relief flow path 8a. That is, when the leakage of the first fluid or the second fluid occurs from the corner portion 11, the fluid flows out to the first relief flow path 8a. Accordingly, the leakage of the first fluid or the second fluid can be reliably detected only by monitoring the first relief flow path 8a. This allows the flow path device 1 according to the present embodiment to promptly take countermeasure against the leakage of the first fluid or the second fluid.

The “vicinity of the corner portion 11” may be, for example, a distance where the first fluid or the second fluid leaked from the corner portion 11 reaches. The distance between the corner portion 11 and the first relief groove 7a may be, for example, within 5 times the distance between the corner portion 11 and the edge of the first groove 6a opposite to the corner portion 11. The distance between the corner portion 11 and the first relief groove 7a may be, for example, within 10 mm. Preferably, the one surface 311A of the pair of first main surfaces does not have an opening between the corner portion 11 and the first relief groove 7a. This increases the possibility that the first fluid or the second fluid, which has leaked from the corner portion 11, flows into the first relief flow path 8a.

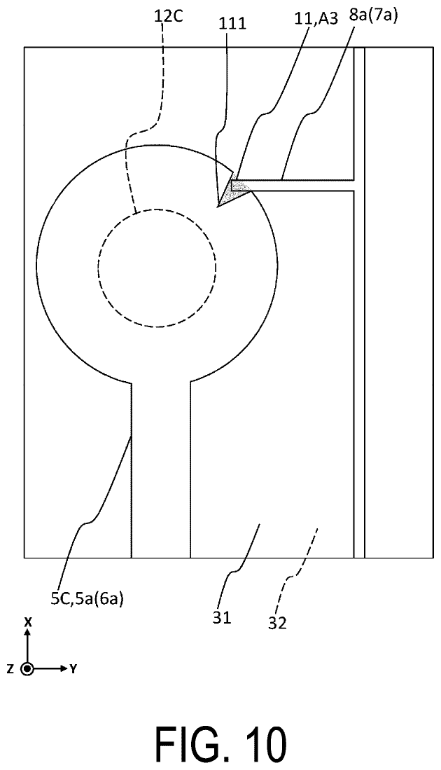

Furthermore, as illustrated in FIG. 10, the first relief groove 7a may be formed at the corner portion 11 in plan view. As a result, the first relief groove 7a is provided at the corner portion 11, and thus when the first member 31 and the second member 32 separate from each other originating from the corner 111 at the corner portion 11, the first fluid or the second fluid, which has flown in from the separated portion, more reliably flows out to the first relief flow path 8a.

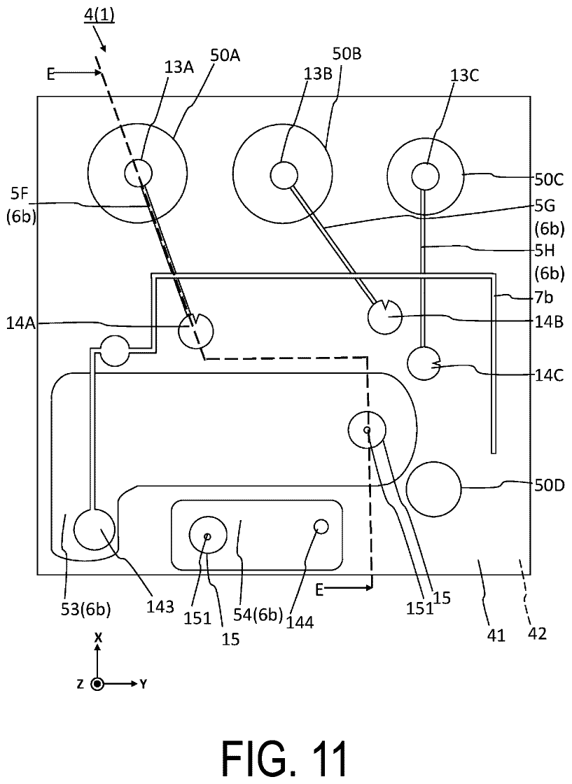

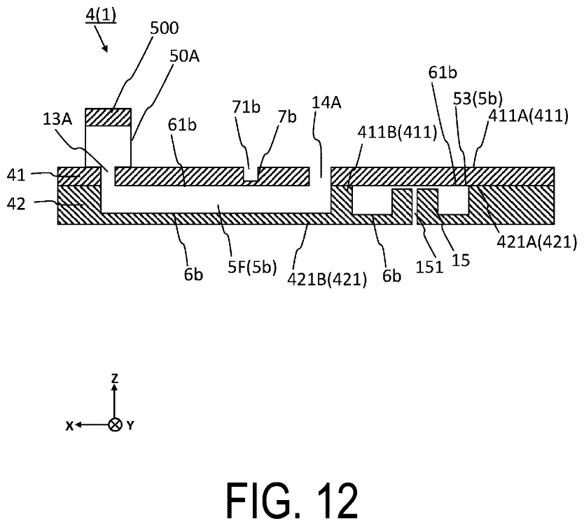

The base flow path device 4 will be described with reference to FIGS. 11 and 12. FIG. 11 is a plan view of the base flow path device 4. FIG. 12 is a cross-sectional view of the base flow path device 4 taken along a line E-E illustrated in FIG. 11. Note that, FIG. 11 is a plane perspective view of the base flow path device 4.

The third member 41 is, for example, a flat plate member. The third member 41 includes a pair of third main surfaces 411 as upper and lower surfaces. In the third member 41 according to the present embodiment, among the pair of third main surfaces 411, the third main surface 411 located in the positive direction of the Z-axis is defined as one surface 411A of the pair of third main surfaces, and the third main surface 411 located in the negative direction of the Z-axis is defined as the other surface 411B of the pair of third main surfaces. The third member 41, similarly to the first member, includes a second relief groove 7b, which includes an opening 71b located in the one surface 411A of the pair of third main surfaces.

The fourth member 42 is, for example, a flat plate member. The fourth member 42 includes a pair of fourth main surfaces 421 as upper and lower surfaces. In the fourth member 42 according to the present embodiment, among the pair of fourth main surfaces 421, the fourth main surface 421 located in the positive direction of the Z-axis is defined as one surface 421A of the pair of fourth main surfaces, and the fourth main surface 421 located in the negative direction of the Z-axis is defined as the other surface 421B of the pair of fourth main surfaces. The fourth member 42, same as the first member 31, includes a second groove 6b, which includes an opening 61b located in the one surface 421A of the pair of fourth main surfaces.

In the third member 41, the other surface 412B of the pair of third main surfaces is joined to the one surface 421A of the pair of fourth main surfaces of the fourth member 42. The third member 41 is joined so as to close the opening 61b of the second groove 6b of the fourth member 42. Thus, by joining the third member 41 and the fourth member 42, the second groove 6b including the opening 61b in the fourth member 42 is configured as a second flow path 5b.

The width of the second groove 6b in the fourth member 42 may be, for example, 10 μm to 10 mm. The depth of the second groove 6b may be, for example, 30 μm to 4000 μm. The width of the second relief groove 7b in the third member 41 may be, for example, 20 μm to 1000 μm. The depth of the second relief groove 7b may be, for example, 5 μm to 500 μm. The second groove 6b and the second relief groove 7b in the fourth member 42 may be formed by, for example, known techniques such as mold, etching, laser machining process, or the like.

Same as the first member 31 and the second member 32, the third member 41 and the fourth member 42 may be, for example, joined via double-sided tape, adhesive, plasma bonding, or optical bonding.

The material of the third member 41 may be, for example, COP (cycloolefin polymer) resin, COC (cyclic olefin copolymer) resin, PDMS (polydimethylsiloxane) resin, PMMA (polymethyl methacrylate: acrylic) resin, glass, polycarbonate resin, or the like. The material of the third member 41 according to the present embodiment is a polycarbonate resin. The thickness of the third member 41 may be, for example, 0.5 mm to 3 mm.

The material of the fourth member 42 may be, for example, COP (cycloolefin polymer) resin, COC (cyclic olefin copolymer) resin, PDMS (polydimethylsiloxane) resin, PMMA (polymethyl methacrylate: acrylic) resin, glass, polycarbonate resin, or the like. The material of the fourth member 42 according to the present embodiment is a polycarbonate resin. The thickness of the fourth member 42 may be, for example, 1 mm to 6 mm. Note that the thickness of the fourth member 42 may be larger than that of the third member 41, but may be smaller than that of the third member 41. The length of the third member 41 and the fourth member 42 may be, for example, 10 to 50 mm along the Y-axis direction and 10 to 50 mm along the X-axis direction.

The second flow path 5b in the base flow path device 4 according to the present embodiment includes flow paths 5F, 5G, 5H, and reservoir flow paths 53 and 54. The third member 41 includes inflow ports 13A, 13B, and 13C that connect the supply units 50A, 50B, and 50C and the second groove 6b that constitutes the flow paths 5F, 5G, and 5H, respectively. Thus, the first fluid flows into the flow path 5F from the supply unit 50A through an inflow port 13A. The second fluid flows into the flow path 5G and flow path 5H from the supply unit 50B and the supply unit 50C through inflow ports 13B and 13C, respectively. The supply units 50A, 50B, and 50C according to the present embodiment each include a rubber cap 500. Positive pressure can be applied to each of the first fluid and the second fluid by pressing the corresponding rubber cap 500. As a method of pressing the rubber cap 500, for example, a pusher may be used or a hand may be used.

The third member 41 further includes connection holes 14A, 14B, 14C, 143, and 144 that are connected to the flow paths 5F, 5G, 5H, and the second groove 6b that constitutes the reservoir flow paths 53 and 54, respectively. The connection holes 14A, 14B, 14C, 143, and 144 are connected to the through holes 12A, 12B, 12C, 12E, and 121 of the second member 32, respectively. Thus, the first fluid flows from the flow path 5F to the flow path 5A through the connection hole 14A and the through hole 12A. The second fluid flows from the flow path 5G to the flow path 5B through the connection hole 14B and the through hole 12B. The second fluid flows from the flow path 5H to the flow path 5C through the connection hole 14C and the through hole 12C. The third fluid flows from the flow path 5E to the reservoir flow path 53 through the through hole 12E and a connection hole 143. The fifth fluid flows from the pressing flow path 51 to the reservoir flow path 54 through the through hole 121 and a connection hole 144. Furthermore, the connection hole 143 is connected to the second relief groove 7b in the third member 41.

The fourth member 42 includes a protruding portion 15 in the second groove 6b that forms the reservoir flow paths 53 and 54. The protruding portion 15 has a vent hole 151 having an opening on the upper and lower surfaces of the protruding portion 15. This prevents the third fluid and the fifth fluid, which flow through the reservoir flow paths 53 and 54, respectively, from flowing out to the outside of the flow path device 1, and provides a passage for air between each of the reservoir flow paths 53 and 54, and the outside of the flow path device 1. The air in the reservoir flow paths 53 and 54 can be discharged to the outside of the flow path device 1 by the respective vent holes 151. This prevents the stagnation of the flow of the third fluid and the fifth fluid due to the inability of the air to be discharged to the outside of the flow path device 1 in each of the reservoir flow paths 53 and 54. The vent hole 151 may also include a liquid leakage prevention film. The liquid leakage prevention film has a property that does not pass the fluid but passes the air. Thus, the leakage prevention film does not pass the fluid, thereby prevents the third fluid and the fifth fluid from flowing out of the flow path device 1. Furthermore, the leakage prevention film has the property to pass the air, thereby preventing further the stagnation of the flow of the third fluid and the fifth fluid due to the inability of the air to be discharged out from the reservoir flow paths 53 and 54.

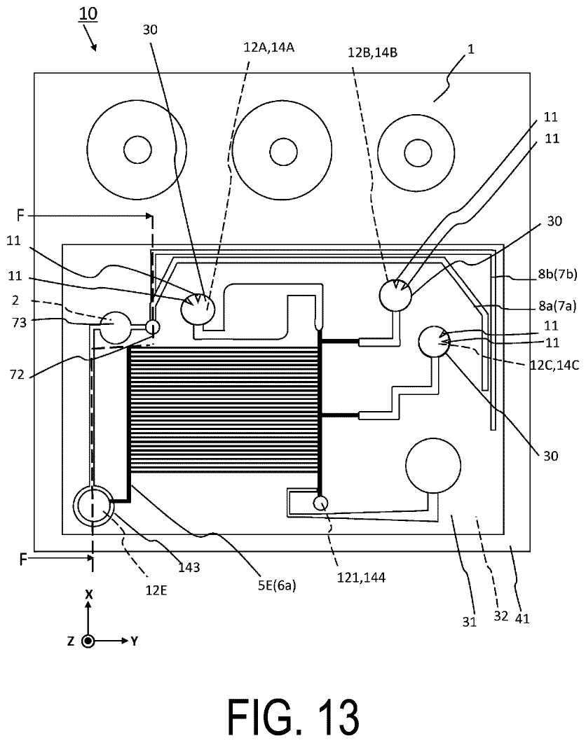

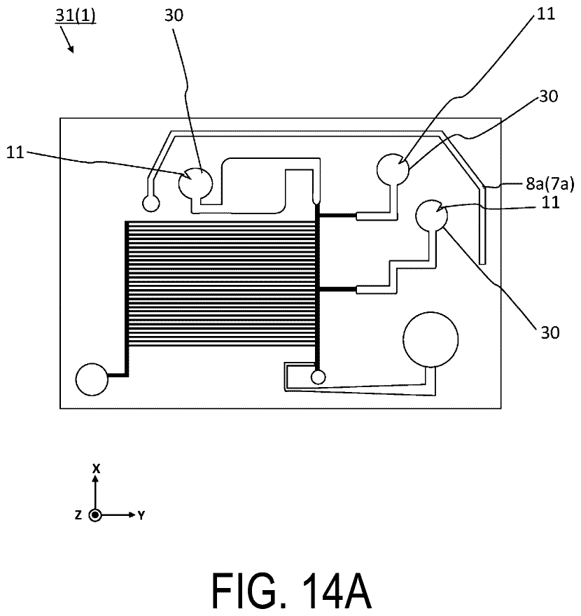

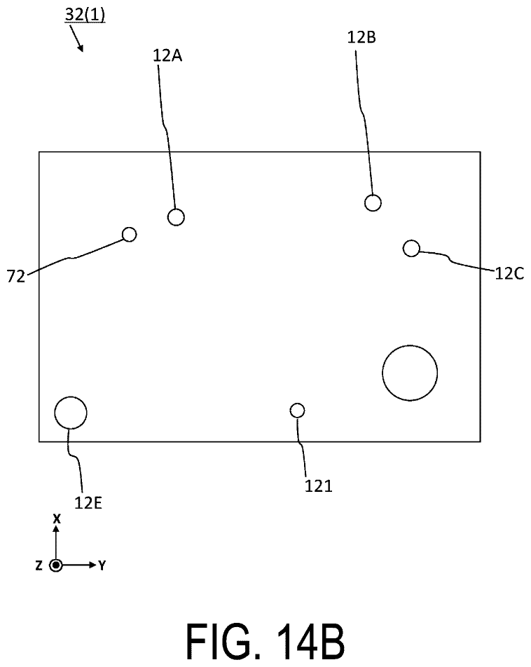

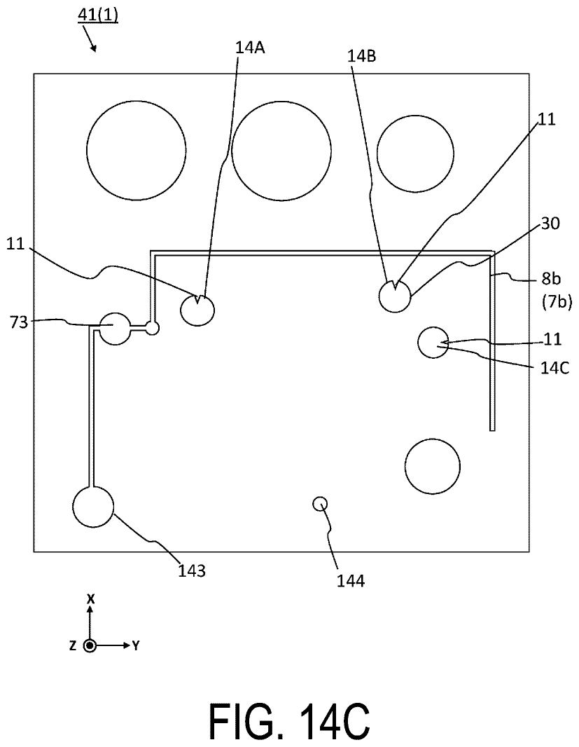

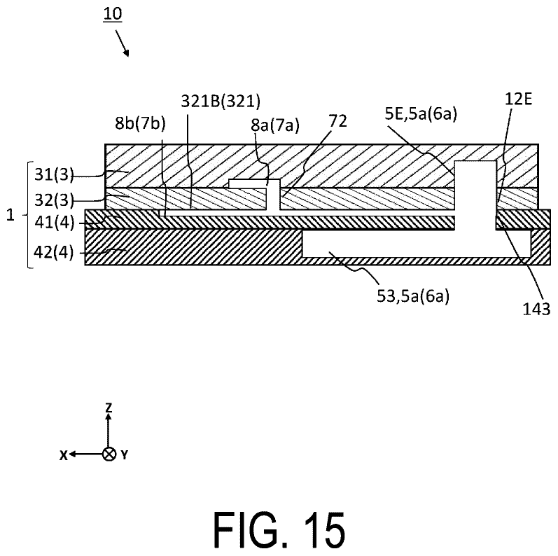

With reference to FIGS. 13, 14, and 15, the configuration will be described of the first groove 6a, the second groove 6b, the first relief groove 7a, and the second relief groove 7b of the flow path device 1 and the detection device 10 according to the present embodiment. FIG. 13 is a plan view of the detection device 10. FIG. 14A is a plan view of only the first member 31 illustrated in FIG. 13. FIG. 14B is a plan view of only the second member 32 illustrated in FIG. 13. FIG. 14C is a plan view of only the third member 41 illustrated in FIG. 13. FIG. 15 is a cross-sectional view of the detection device 10 taken along a line F-F illustrated in FIG. 13. Note that FIGS. 13 and 14 illustrate the flow path device 1 in plane perspective. In FIG. 13, the illustration of the fourth member 42 of the detection device 10 is omitted. In FIG. 15, the fourth member 42 is not omitted.

The third member 41 is joined to the other surface 321B of the pair of second main surfaces of the second member 32. The second member 32 and the third member 41 may be, for example, joined via adhesive, plasma bonding, or optical bonding.

As described above, the connection holes 14A, 14B, 14C, 143, and 144 are connected to the through holes 12A, 12B, 12C, 12E, and 121, respectively. Thus, the connection hole 14A, together with the through hole 12A, functions as an inflow opening for the first fluid to the flow path 5A. The connection holes 14B and 14C, together with the corresponding through holes 12B and 12C, function as an inflow opening for the second fluid to the flow path 5B and 5C, respectively. The connection hole 143, together with the through hole 12E, functions as an outflow opening for the third fluid from the flow path 5E. The connection hole 144, together with the through hole 121, functions as an outflow opening for the fifth fluid from the pressing flow path 51.

The first fluid flows into the flow path 5A via the through hole 12A and the connection hole 14A. The second fluid flows into the flow path 5B via the through hole 12B and the connection hole 14B, and concurrently flows into the flow path 5C through the through hole 12C and the connection hole 14C. Additionally, the third fluid flows out of the through hole 12E and the connection hole 143 via the flow path 5E, and the fifth fluid flows out of the through hole 121 and the connection hole 144 through the pressing flow path 51. As a result, pressure is applied to the respective inner walls of the through holes 12A, 12B, 12C, 12E, 121 and the connection holes 14A, 14B, 14C, 143, 144, so that there is a possibility that the second member 32 and the third member 41 can separate from each other. Thus, so-called fluid leakage can occur, in which the separated portion formed between the second member 32 and the third member 41 is flown in by: the first fluid flowing through the through hole 12A and the connection hole 14A; the second fluid flowing through the through hole 12B and the connection hole 14B, and through the through hole 12C and the connection hole 14C; the third fluid flowing through the through hole 12E and the connection hole 143; and the fifth fluid flowing through the through hole 121 and the connection hole 144.

Thus, in the flow path device 1 according to the present embodiment, the corner portions 11 are formed at the respective edges of the connection holes 14A, 14B, 14C, and the corner portions 11 are not formed at the edges of the connection holes 14A, 14B, 14C opposite to the corner portions 11, respectively. As a result, when the second member 32 and the third member 41 separate from each other, this separation is likely to originate from the corner 111. This can reliably detect leakage of the first fluid or the second fluid by monitoring only the periphery of the corner portions 11 without monitoring all the peripheries of the connection holes 14A, 14B, 14C, by intentionally forming the corner portions 11 even at the edges of the connection holes 14A, 14B, 14C, respectively. In the flow path device 1 according to the present embodiment, the corner portions 11 are formed on the connection holes 14A, 14B, 14C which function as inflow openings for inflow of the first fluid or the second fluid into the flow paths 5A, 5B, 5C, respectively, but not limited to this configuration. The corner portion 11 may also be formed in the connection hole 143 which functions as an outflow opening for outflow of the third fluid from the flow path 5E, and the connection hole 144 which functions as an outflow opening for outflow of fifth fluid from the pressing flow path 51.

The connection holes 14A, 14B, 14C, 143 and 144 of the third member 41 are connected to the second grooves 6b which constitute the flow paths 5F, 5G and 5H and the reservoir flow paths 53 and 54, respectively. The second grooves 6b are formed in the fourth member 42. Thus, the third member 41, which includes the connection holes 14A, 14B, 14C, 143 and 144, does not include the second grooves 6b, so that the rigidity of the third member 41 increases compared to the case where the third member 41 includes the second grooves 6b in addition to the connection holes 14A, 14B, 14C, 143 and 144. This may cause separation less likely to occur between the second member 32 and the third member 41 in the flow path device 1 according to the present embodiment.

As illustrated in FIG. 13, in plan view, the corner portions 11 formed at the edges of the first planar portions 30 does not overlap with the corner portions 11 formed at the edges of the connection holes 14A, 14B and 14C, respectively. In plan view, when the corner portion 11 formed at the edge of the first planar portion 30 overlaps with the corner portion 11 formed at the edge of either of the connection holes 14A, 14B and 14C, determination is not easy from which corner portion 11 the first fluid or the second fluid has leaked. In the flow path device 1 according to the present embodiment, in plan view, the corner portions 11 formed at the edges of the first planar portions 30 do not overlap with the corner portions 11 formed at the edge of the connection holes 14A, 14B and 14C, respectively, determination is easy from which corner portion 11 the first fluid or the second fluid has leaked. As a result, in the flow path device 1 according to the present embodiment, even when the corner portions 11 are formed at the edges of the first planar portions 30 and at the edges of the connection holes 14A, 14B, and 14C, countermeasures against the leakage of the first fluid or the second fluid can be promptly taken.

In the second member 32, the other surface 321B of the pair of second main surfaces is joined to the one surface 411A of the pair of third main surfaces of the third member 41 so as to close the opening 71b of the second relief groove 7b, and thus the second relief groove 7b including the opening 71b in the third member 41 is configured as a second relief flow path 8b.

The second relief groove 7b is provided in the vicinity of the corner portions 11 of the respective connection holes 14A, 14B, and 14C. The second relief groove 7b is provided in the vicinity of the corner portions 11 of the respective connection holes 14A, 14B, and 14C, and thus when the second member 32 and the third member 41 separate from each other originating from the corner 111 of the corner portion 11 at the edge of any of connection holes 14A, 14B, and 14C, the first fluid or the second fluid, which has flown in from the separated portion, flows out to the second relief flow path 8b. That is, when the first fluid or the second fluid leaks from the corner portion 11 of any of connection holes 14A, 14B, and 14C, the first fluid or the second fluid flows out to the second relief flow path 8b. Thus, the leakage of the first fluid or the second fluid can be reliably detected only by monitoring the second relief flow path 8b. This allows the flow path device 1 according to the present embodiment to promptly take countermeasure against the leakage of the first fluid or the second fluid. The second relief groove 7b may be formed at the corner portions 11 of the respective connection holes 14A, 14B, and 14C. As a result, the second relief groove 7b is provided at the corner portion 11 as above, and thus when the second member 32 and the third member 41 separate from each other originating from the corner 111, so that the first fluid or the second fluid that flows in from the separated portion more reliably flows out to the second relief flow path 8b.

In the flow path device 1, the second relief groove 7b is formed in the third member 41 and the second groove 6b is formed in the fourth member 42, so that the degree of freedom in the thickness of the third member 41 and degree of freedom of the arrangement of the second relief groove 7b is higher than when both the second relief groove 7b and the second groove 6b are formed in the third member.

The second member 32 according to the present embodiment includes a relief connection hole 72 connecting the first relief groove 7a and the second relief groove 7b. When the first fluid or the second fluid leaks from the corner portion 11 of the first groove 6a, the first fluid or the second fluid flows out to the first relief flow path 8a. When the first fluid or the second fluid leaks from the corner portion 11 of any of the connection holes 14A, 14B, 14C, the first fluid or the second fluid flows out to the second relief flow path 8b. Thus, the second member 32 according to the present embodiment includes the relief connection hole 72 connecting the first relief groove 7a and the second relief groove 7b. Thus, the first fluid or the second fluid flowing through the first relief flow path 8a flows to the second relief flow path 8b through the relief connection hole 72. Thereby, the leakage of the first fluid or the second fluid can be reliably detected by monitoring only the second relief flow path 8b without monitoring both the first relief flow path 8a and the second relief flow path 8b in the flow path device 1.

The second relief groove 7b according to the present embodiment includes a large width portion 73. The large width portion 73 has a large area in plan view, so that much amount of first or second fluids flow in the second relief flow path 8b in the large width portion 73. Thus, detection is easy for the first or second fluid flowing in the second relief flow path 8b in the large width portion 73. The detector 2 can detect the first or second fluid flowing in the large width portion 73. The detection device 10 includes the relief connection hole 72, so that the detector 2 for the first relief flow path 8a and the detector 2 for the second relief flow path 8b are not both necessary. The leakage can be detected of the first or second fluid from both the corner portion 11 of the second groove 6b and the corner portion 11 of any of the connection holes 14A, 14B, and 14C only by including the detector 2 for detecting the first or second fluid flowing in the second relief flow path 8b. The detection device 10 according to the present embodiment only includes the detector 2 for detecting the first or second fluid flowing in the second relief flow path 8b, but both of the detector 2 for the first relief flow path 8a and the detector 2 for the second relief flow path 8b, may be included. This enables to determine easily that the first fluid or second fluid has leaked whether from the corner portion 11 formed at the edge of the first groove 6a, or from the corner portion 11 formed at the edge of any of the connection holes 14A, 14B, and 14C.

The second relief groove 7b according to the present embodiment is connected to the connection hole 143, thereby the first or second fluid flowing in the second relief flow path 8b flows into the reservoir flow path 53 through the connection hole 143. The reservoir flow path 53 has the hole 151, and thus the first fluid or the second fluid that has leaked from the corner portion 11 quickly flows in the first relief flow path 8a or the second relief flow path 8b. Thus, the first fluid or the second fluid that has leaked from the corner portion 11 can be quickly detected by the detector 2.

The detection device 10 according to the present embodiment has a shallower depth of the first relief groove 7a or the second relief groove 7b than that of the first groove 6a. The depth of the first relief groove 7a or the second relief groove 7b is shallower than that of the first groove 6a, so that the speed of the first fluid or the second fluid that flows in the first relief groove 7a or the second relief groove 7b increases. Thus, the first fluid or the second fluid that flows in the first relief groove 7a or the second relief groove 7b can be quickly detected by the detector 2. This allows the detection device 10 to promptly take countermeasure against the leakage of the first fluid or the second fluid. In the flow path device 1 according to the present embodiment, the depth of the first relief groove 7a and the second relief groove 7b is each shallower than that of the first groove 6a, so that the speeds of the first fluid and the second fluid that flow in the first relief groove 7a and the second relief groove 7b increases, respectively.

The detector 2 according to the present embodiment, by the light emitting element, irradiates the first fluid or the second fluid that flows in the large width portion 73 in the second relief flow path 8b, and can receive, by the light receiving element, the light passing through the first fluid or the second fluid. This can detect the leaked first fluid or the leaked second fluid at the large width portion 73, based on the output of the detector 2. The flow path device 1 according to the present embodiment may further include a mirror, which is a reflecting member arranged in a region overlapping with the large width portion 73 in the other surface 311B of the pair of first main surfaces of the first member 31. The mirror can reflect the light that has passed through the large width portion 73 among the light emitted from the light emitting element of the optical sensor to the light receiving element of the optical sensor. Instead of the detector 2, the leakage of the first fluid or the second fluid may be detected visually. In the case of visual inspection, the first member 31, the second member 32, the third member 41, and the fourth member 42 may be permeable.

### Second Embodiment

A flow path device 1a and a detection device 10a according to a second embodiment will be described below. In the description of the flow path device 1a and the detection device 10a according to the present embodiment, basically, only the differences from the flow path device 1 and the detection device 10 according to the first embodiment will be described. The matters which are not specifically mentioned may be the same as those of the first embodiment or may be analogized from the first embodiment. Note that the same applies to a third embodiment described below.

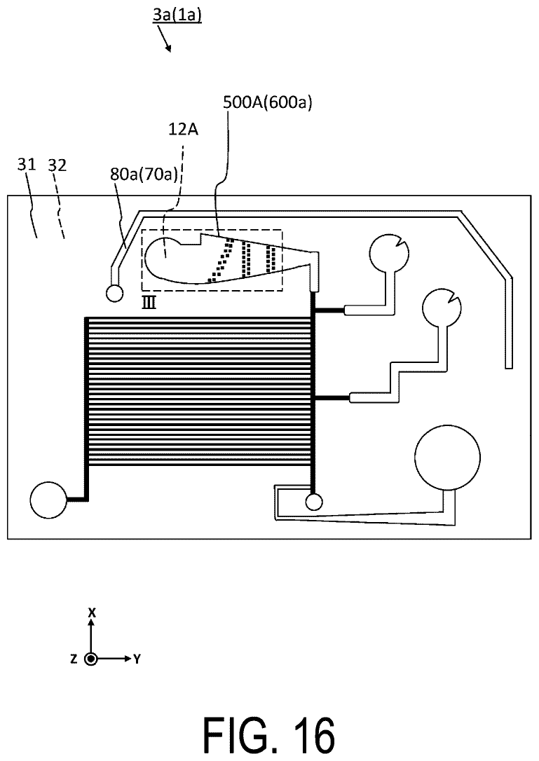

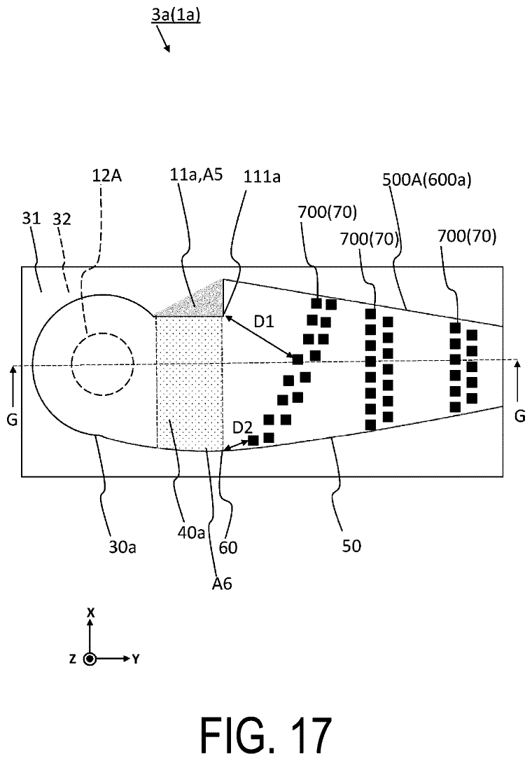

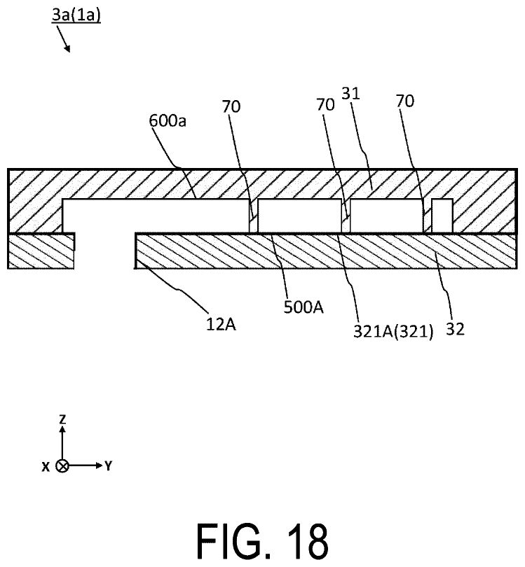

Referring to FIGS. 16, 17, and 18, the configuration of the vicinity of a corner portion 11a and the corner portion 11a formed at the edge of a first groove 600a according to the present embodiment, will be described. FIG. 16 is a plan view of a separation flow path device 3a according to the present embodiment. FIG. 17 is an enlarged plan view of the region III illustrated in FIG. 16. FIG. 18 is a cross-sectional view of the separation flow path device 3a taken along a line G-G illustrated in FIG. 17. Note that FIGS. 16 and 17 illustrate the separation flow path device 3a in plane perspective.

In plan view, the first groove 600a constituting a flow path 500A includes a circular first planar portion 30a including the through hole 12A, a second planar portion 40a connected to the first planar portion, and a third planar portion 50 connected to the second planar portion 40a. The second planar portion 40a and the third planar portion 50 are connected to each other by a connecting portion 60.

When the first fluid flows in the thickness direction via the through hole 12A, the first fluid that has flown in flows vigorously from the second planar portion 40a toward the third planar portion 50 through the connecting portion 60. The width of the third planar portion 50 on the connecting portion 60 side is larger than the width of the second planar portion 40a on the connecting portion 60 side. Thus, the stress applied to the connecting portion 60 is larger than that of the second planar portion 40a and that of the third planar portion 50. The corner portion 11a is formed at the edge of such connecting portion 60, and the corner portion 11a is not formed on the connecting portion 60 opposite to the corner portion 11a. In FIG. 17, a fifth region A5 illustrated in gray indicates the corner portion 11a. In the first groove 600a constituting the flow path 500A, the corner portion 11a is located on the positive side of the X axis of the first groove 600a, and thus, the edge of the first groove 600a opposite to the corner portion 11 indicates the edge of the first groove 600a located on the negative side of the X axis. In FIG. 17, a hatched sixth region A6 indicates the opposite region.

As a result, in the connecting portion 60, the stress is concentrated especially on a corner 111a of the corner portion 11a, so that the first member 31 and the second member 32 may be more likely to separate from each other originating from the corner 111a. Thus, the leakage of the first fluid can be reliably detected by monitoring only the periphery of the corner portion 11a formed at the edge of the connecting portion 60 without monitoring all of the periphery of the first groove 600a in the flow path device 1a.

The first member 31 according to the present embodiment includes a plurality of columnar bodies 70 arranged on the first groove 600a. The plurality of columnar bodies 70 are joined to the one surface 321A of the pair of second main surfaces of the second member 32.

The columnar bodies 70 are joined to the one surface 321A of the pair of second main surfaces of the second member 32, thereby the first member 31 and the second member 32 are less likely to deflect in this vicinity. A distance D1 between the corner portion 11a and the columnar body 70 arranged closest to the corner portion 11a is larger than a distance D2 between the edge of the first groove 600a opposite to the corner portion 11a and the columnar body 70 arranged closest to this edge. This makes the first member 31 and the second member 32 more likely to deflect at the corner portion 11a than the edge of the first groove 600a opposite to the corner portion 11a. Thus, stress is concentrated at the corner 111a of the corner portion 11a, and the first member 31 and the second member 32 tend to deflect at the corner portion 11a. Accordingly, the first member 31 and the second member 32, when separating from each other, are more likely to originate from the corner portion 11a.

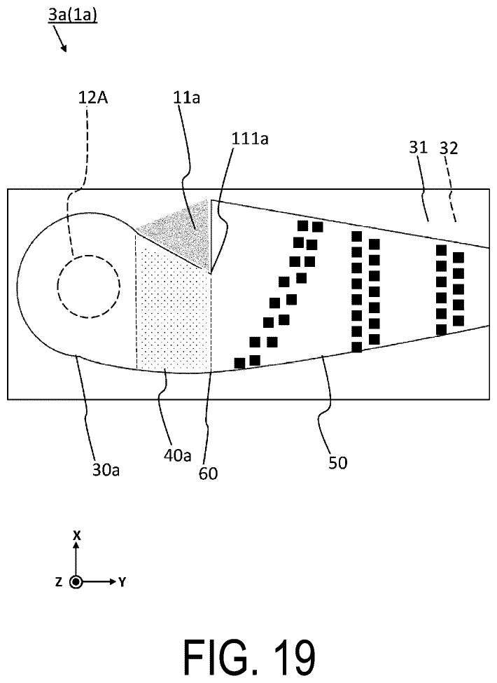

The size and shape of the plurality of columnar bodies 70 may each be, for example, a cylindrical columnar body having a diameter of about 20 μm, a square columnar body having a side of about 20 μm, or a square columnar body having a width of about 20 μm and a length of about 60 μm. In FIG. 19, the width direction is the X-axis direction, and the length direction is the Y-axis direction. The arrangement and the number of the columnar bodies 70 may be, for example, arranged at an interval of about 30 μm in the width direction of the flow path 500A, and about 2 rows arranged at an interval of about 30 μm in the length direction. In this way, the plurality of columnar bodies 70 are arranged in the width direction of the first groove 600a to constitute a pillar portion 700. This can filter and remove foreign matter such as dust, if mixed in the first fluid in addition to particles, the foreign matter can be filtered and removed by the plurality of columnar bodies 70 at the pillar portion 700, thereby eliminating the influence of foreign matter on the separation of particles to be separated.

The first groove 600a constituting the flow path 500A according to the present embodiment includes one or more pillar portions 700 in the third planar portion 50. The pillar portions 700 are provided at 3 locations. When a plurality of pillar portions 700 are provided, the distance between the pillar portions 700 may be, for example, about 0.5 to 1 mm. The distance and the number of columnar bodies 70 may be different from each other in each of the plurality of pillar portions 700.

As illustrated in FIG. 19, the corner 111a formed by the half-lines at the corner portion 11a may have an acute angle. This allows a stress to concentrate on the corner portion 11a, especially the corner 111a, so that the first member 31 and the second member 32 are more likely to separate from each other originating from the corner 111a. Accordingly, if the first member 31 and the second member 32 separate from each other, this separation is more likely to originate from the corner 111a.

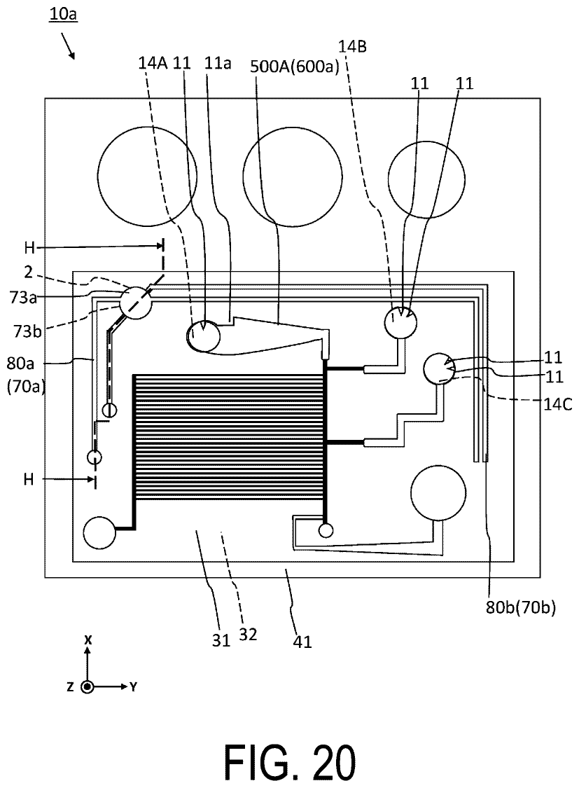

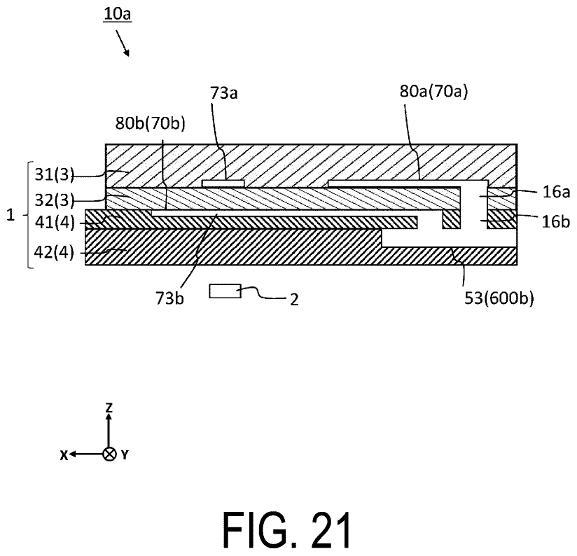

A first relief groove 70a and a second relief groove 70b of the flow path device la and the detection device 10a according to the present embodiment will be described with reference to FIGS. 20 and 21. FIG. 20 is a plan view of the detection device 10a according to the present embodiment. FIG. 21 is a cross-sectional view of the detection device 10a taken along a H-H line illustrated in FIG. 20. Note that FIG. 20 illustrates the detection device 10a in plane perspective. In FIG. 20, the illustration of the fourth member 42 of the detection device 10a is omitted. In FIG. 21, the fourth member 42 is not omitted for illustration.

In the detection device 10a according to the present embodiment, the first fluid or the second fluid, when leaking from the corner portions 11 and 11a of the first groove 600a of the first member 31, flows out to a first relief flow path 80a. The first fluid or the second fluid, when leaking from the corner portion 11 of any of the connection holes 14A, 14B and 14C, flows out to a second relief flow path 80b.

In the detection device 10a according to the present embodiment, in plan view, the first relief groove 70a includes a first large width portion 73a and the second relief groove 70b includes a second large width portion 73b. The areas of the first large width portion 73a and the second large width portion 73b are each large in plan view, large amount of first fluid or the second fluid flow in the first relief flow path 80a in the first large width portion 73a and the second relief flow path 80b in the second large width portion 73b. This can easily detect the first fluid or the second fluid flowing in the first relief flow path 80a in the first large width portion 73a and the second relief flow path 80b in the second large width portion 73b. Thus, the detection device 10a according to the present embodiment needs not separately provide the detector 2 for the first relief flow path 80a and the detector 2 for the second relief flow path 80b. Instead, by providing only one detector 2 for detecting the first fluid or the second fluid flowing in the first relief flow path 80a in the first large width portion 73a and the second relief flow path 80b in the second large width portion 73b, the leakage can be detected of the first fluid or the second fluid from the corner portion 11 or 11a of the first groove 600a, or the corner portion 11 of any of the connection holes 14A, 14B and 14C.

The detector 2 according to the present embodiment is located on the negative side of the Z-axis of the flow path device 1a. The detector 2 overlaps with the first large width portion 73a and the second large width portion 73b in plan view. This can easily detect the first fluid or the second fluid flowing in the first relief flow path 80a in the first large width portion 73a and the second relief flow path 80b in the second large width portion 73b.

The first relief groove 70a is connected to a through hole 16a opening in the upper and lower surfaces of the second member 32. Furthermore, the hole 16a is connected to a through hole 16b opening in the upper and lower surfaces of the third member 41.

Furthermore, the hole 16b is connected to a second groove 600b constituting the reservoir flow path 53. Thus, the first fluid or second fluid flows from the first relief flow path 80a into the reservoir flow path 53 through the holes 16a and 16b.

The second member 32 includes a hole 16c, which connects to the second relief groove 70b, and the second groove 600b constituting the reservoir flow path 53. Thus, the first fluid or the second fluid flows from the second relief flow path 80b into the reservoir flow path 53 via the hole 16c.

The first fluid or the second fluid that has leaked from the corner portions 11 and 11a flows through the first relief flow path 80a or the second relief flow path 80b to the reservoir flow path 53 including the vent hole 151, thereby flows quickly into the first relief flow path 80a or the second relief flow path 80b. Thus, the first fluid or the second fluid that has leaked from the corner portion 11, 11a can be quickly detected by the detector 2.

### Third Embodiment

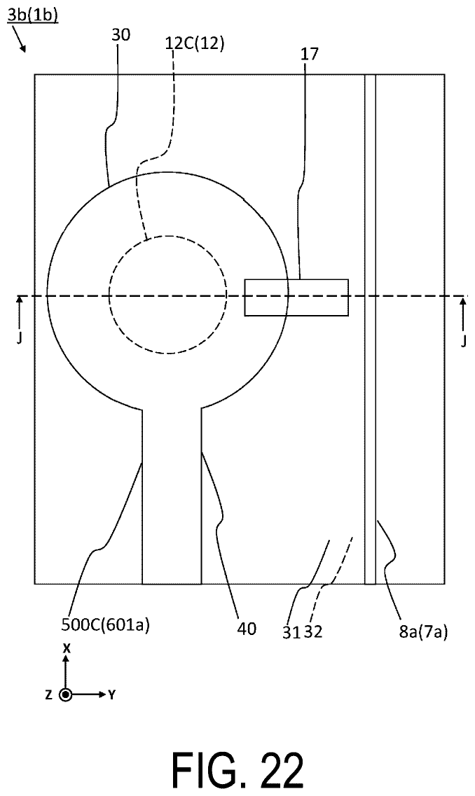

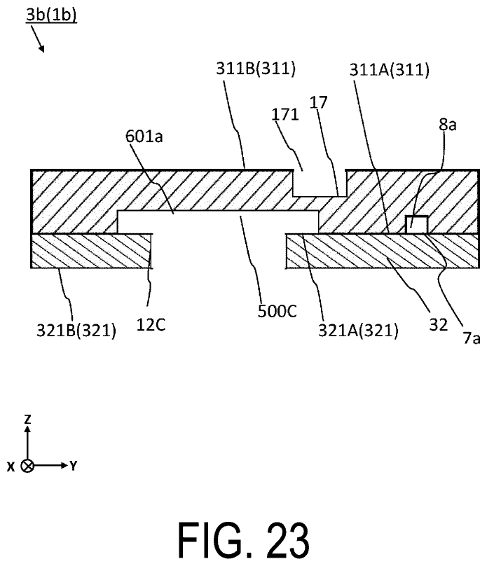

Referring to FIGS. 22 and 23, the configuration of a recessed portion 17 and the vicinity of the recessed portion 17 formed at the edge of a first groove 601a according to a third embodiment, will be described. FIG. 22 is a plan view of a portion of a separation flow path device 3b according to the present embodiment, and corresponds to an enlarged view of the region II in FIG. 6. FIG. 23 is a cross-sectional view of the separation flow path device 3b taken along the J-J line illustrated in FIG. 22. Note that FIG. 22 illustrates the separation flow path device 3b in plane perspective.

The first member 31 according to the present embodiment includes the recessed portion 17, which includes an opening 171 located in the other surface 311B of the first main surface and overlaps with a portion of the periphery of the first groove 601a constituting a flow path 500C.

As a result, the first member 31 tends to deflect in the portion including the recessed portion 17 in plan view, so that the first member 31 and the second member 32 are likely to separate from each other, when separating, at the portion including the recessed portion 17. Thus, the leakage of the second fluid can be reliably detected by monitoring only the periphery of the recessed portion 17 without monitoring all of the periphery of the first groove 601a in a flow path device 1b. This allows the flow path device 1b according to the present embodiment to promptly take countermeasure against the leakage of the second fluid.

The depth of the recessed portion 17 is deeper than the depth of the first groove 601a. The depth of the recessed portion 17 is deeper than the depth of the first groove 601a, so that the first member 31 tends to deflect more in the portion including the recessed portion 17. Accordingly, the first member 31 and the second member 32, when separating, are more likely to separate from each other in the portion including the recessed portion 17.

In the flow path device 1b according to the present embodiment, the first member 31 includes the recessed portion 17, while the second member 32 may include a recessed portion, which includes an opening located in the other surface 321B of the second main surfaces and overlaps with the recessed portion 17 of the first member 31. As a result, in plan view, the second member 32 in addition to the first member 31 tends to deflect at the portion where the recessed portion 17 of the first member 31 and the recessed portion of the second member 32 overlap with each other. Thus, the first member 31 and the second member 32, when separating, are more likely to separate from each other at the portion where the recessed portion 17 of the first member 31 and the recessed portion of the second member 32 overlap with each other. In addition, only the second member 32 may include the recessed portion 17.

In plan view, the first relief groove 7a is provided in the vicinity of the recessed portion 17. The first relief groove 7a is provided in the vicinity of the recessed portion 17, the second fluid flowing in from the separated portion flows out to the first relief groove 7a. That is, when the second fluid leaks due to the separation between the first member 31 and the second member 32 in the portion including the recessed portion 17, the second fluid flows out to the first relief groove 7a. Thus, the leakage of the second fluid can be reliably detected only by monitoring the first relief groove 7a. This allows the flow path device 1b to promptly take countermeasure against the leakage of the second fluid.

Here, the vicinity of the recessed portion 17 may be, for example, a distance where the second fluid that has leaked from the portion including the recessed portion 17 reaches. The distance between the portion including the recessed portion 17 and the first relief groove 7a may be, for example, within 5 times the distance between the portion including the recessed portion 17 and the edge of the first groove 601 a opposite to the portion including the recessed portion 17. The distance between the portion including the recessed portion 17 and the first relief groove 7a may be, for example, within 10 mm. Preferably, the one surface 311A of the plurality of first main surfaces does not include an opening between the portion including the recessed portion 17 and the first relief groove 7a. This makes the second fluid, which has leaked from the portion including the recessed portion 17, more likely to flow into the first relief flow path 8a.

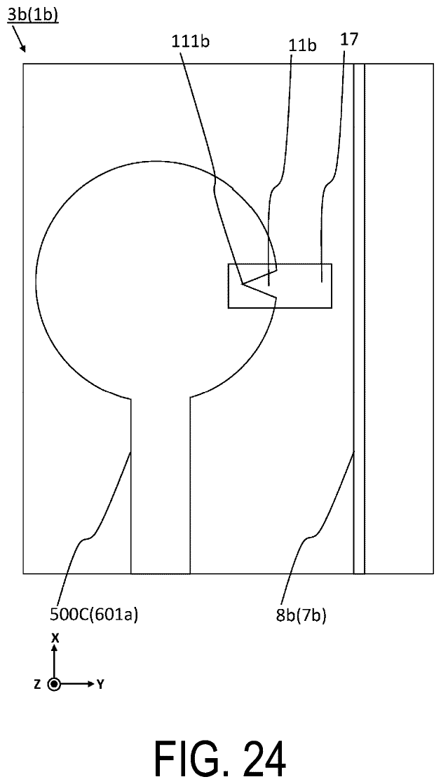

As illustrated in FIG. 24, the first member 31 includes a corner portion 11b at the edge of the first groove 601a, and may include the recessed portion 17 including the corner portion 11b in plan view. This allows a stress to concentrate on a corner 111b of the corner portion 11, so that the first member 31 and the second member 32 are more likely to separate from each other originating from the corner 111b. Furthermore, in plan view, the recessed portion 17 includes the corner portion 11b, and thus the first member 31 tends to deflect in this portion. As a result, the first member 31 and the second member 32, when separating, are more likely to separate from each other originating from the corner 111b of the corner portion 11b.

Note that the first to third embodiments described above may be suitably combined.

1. A flow path device, comprising:
a first member comprising
a pair of first main surfaces, and
a groove comprising an opening located in one surface of the pair of first main surfaces; and
a second member comprising a pair of second main surfaces, one surface of the pair of second main surfaces
being joined to the one surface of the pair of first main surfaces of the first member, and closing the opening,
wherein
the first member or the second member comprises a through hole connected to the groove, and
in plan view,
a corner portion is formed at the edge of the groove, and
no corner portion is formed at the edge of the groove opposite to the corner portion.

2. The flow path device according to claim 1,
wherein in plan view,
the groove comprises:
a first planar portion comprising the through hole, and having a circular shape; and
a second planar portion having a strip shape, and connected to the first planar portion,
wherein
the corner portion is formed at the edge of the first planar portion, and
no corner portion is formed at the edge of the first planar portion opposite to the corner portion.

3. The flow path device according to claim 2, further comprising
a third member comprising a pair of third main surfaces, one surface of the pair of third main surfaces being joined to the other surface of the pair of second main surfaces of the second member,
wherein
the second member comprises the through hole, and
the third member comprises a connection hole connected to the through hole,
in plan view,
a corner portion is formed at the edge of the connection hole, no corner portion is formed at the edge of the connection hole opposite to the corner portion, and
the corner portion formed at the edge of the first planar portion does not overlap with the corner portion formed at the edge of the connection hole.

4. The flow path device according to claim 1, wherein in plan view,
the groove comprises:
a first planar portion
having a circular shape, and
comprising the through hole,
a second planar portion connected to the first planar portion, and
a third planar portion connected to the second planar portion,
wherein
the second planar portion and the third planar portion are connected to each other by a connecting portion,
a width of the third planar portion on the connecting portion side is larger than a width of the second planar portion on the connecting portion side, and
the corner portion is formed at the connecting portion, and no corner portion is formed at the connecting portion opposite to the corner portion.

5. The flow path device according to claim 1,
wherein
the first member further comprises a relief groove that comprises an opening located in the one surface of the pair of first main surfaces,
the one surface of the pair of second main surfaces of the second member
is joined to the one surface of the pair of first main surfaces of the first member, and closes the opening,
in plan view, the relief groove is provided at the corner portion or in the vicinity of the corner portion.

6. The flow path device according to claim 5, further comprising
a third member comprising
a pair of third main surfaces, one surface of the pair of third main surfaces being joined to the other surface of the pair of second main surfaces of the second member,
wherein
the second member comprises the through hole,
the third member comprises
a connection hole connected to the through hole,
in plan view,
a corner portion is formed at the edge of the connection hole, no corner portion is formed at the edge of the connection hole opposite to the corner portion,
when the relief groove is defined as a first relief groove,
the third member further comprises a second relief groove that comprises an opening located in one surface of the pair of third main surfaces,
the other surface of the pair of second main surfaces of the second member
is joined to the one surface of the pair of third main surfaces of the third member, and closes the opening,
the second relief groove is provided at the corner portion or in the vicinity of the corner portion of the connection hole.

7. The flow path device according to claim 6, wherein
the second member comprises a relief connection hole that connects the first relief groove and the second relief groove.

8. A detection device, comprising the flow path device according to claim 6,
wherein in plan view,
the first relief groove comprises a first large width portion,
the second relief groove comprises a second large width portion,
the first large width portion overlaps with the second large width portion, and
the detection device comprises a detector configured to detect fluid flowing through the first large width portion and the second large width portion.

9. The flow path device according to claim 1, further comprising
a third member comprising a pair of third main surfaces, one surface of the pair of third main surfaces being joined to the other surface of the pair of second main surfaces of the second member,
wherein
the second member comprises the through hole, and
the third member comprises a connection hole connected to the through hole,
in plan view,
a corner portion is formed at the edge of the connection hole, no corner portion is formed at the edge of the connection hole opposite to the corner portion.

10. The flow path device according to claim 9, further comprising,
when the groove is defined as the first groove,
a fourth member comprising
a pair of fourth main surfaces, and
a second groove comprising
an opening located in one surface of the pair of fourth main surfaces,
wherein
the other surface of the pair of third main surfaces of the third member is joined to the one surface of the pair of fourth main surfaces of the fourth member and closes the opening, and
the connection hole is connected to the second groove.

11. The flow path device according to claim 1, wherein
the first member comprises a plurality of columnar bodies disposed within the groove,
each of the plurality of columnar bodies is joined to the one surface of the pair of second main surfaces of the second member, and
a distance between the corner portion and one of the plurality of columnar bodies that is closest to the corner portion is greater than
a distance between the edge of the groove opposite to the corner portion and another one of the plurality of columnar bodies that is closest to the edge.

12. A flow path device, comprising:
a first member comprising:
a pair of first main surfaces, and
a groove comprising an opening located in one surface of the pair of first main surfaces; and
a second member comprising a pair of second main surfaces,
one surface of the pair of second main surfaces
being joined to the one surface of the pair of first main surfaces of the first member, and closing the opening,
wherein
the first member or the second member comprises a through hole connected to the groove, and
the first member comprises a recessed portion
comprising an opening located in the other surface of the first main surfaces; and
overlapping with a portion of the periphery of the groove.

13. The flow path device according to claim 12,
wherein the first member further comprises a relief groove that comprises an opening located in one of the pair of first main surfaces,
one surface of the pair of second main surfaces of the second member is joined to one surface of the pair of first main surfaces of the first member and closes the opening of the relief groove, and
in plan view,
the relief groove is provided in the vicinity of the recessed portion.

14. A detection device comprising:
the flow path device according to claim 5; and
a detector configured to detect a fluid flowing in the relief groove.

15. The detection device according to claim 14, wherein
when viewed in cross section, the depth of the relief groove is shallower than the depth of the groove.

16. A flow path device, comprising:
a first member comprising
a pair of first main surfaces,
a groove comprising an opening located in one surface of the pair of first main surfaces, and
a relief groove comprising an opening located in the one surface of the pair of first main surfaces; and
a second member comprising a pair of second main surfaces, one surface of the pair of second main surfaces
being joined to the one surface of the pair of first main surfaces of the first member, and
closing the opening of the groove and the opening of the relief groove,
wherein
in a case where fluid leaks from the groove, the fluid flows through the relief groove.

17. The flow path device according to claim 16, wherein
the relief groove is not connected to the groove.

18. The flow path device according to claim 16, wherein
in a cross-sectional view, a depth of the relief groove is shallower than a depth of the groove.

19. The flow path device according to claim 16, wherein
the second member comprises a discharge hole connected to the groove, and
the relief groove is connected to the discharge hole.

20. A detection device comprising:
the flow path device according to claim 16; and
a detector configured to detect the fluid flowing through the relief groove.
